(19) United States
(12) Patent Application Publication
(10) Pub. No.: US 2019/0134647 A1
(43) Pub. Date: May 9, 2019

(54) CYCLONE TYPE DUST COLLECTING APPARATUS

(71) Applicant: Nidec Corporation, Kyoto (JP)

(72) Inventors: Ryosuke HAYAMITSU, Kyoto (JP); Yuuichi SAKUMA, Kyoto (JP)

(21) Appl. No.: 15/981,943

(22) Filed: May 17, 2018

Related U.S. Application Data
(63) Continuation of application No. PCT/JP2016/083741, filed on Nov. 15, 2016.

(30) Foreign Application Priority Data
Nov. 26, 2015 (JP) 2015-230230

(51) Int. Cl. B04C 3/06; B04C 9/00; B04C 11/00; A47L 9/16

(52) U.S. Cl. CPC B04C 3/06; B04C 9/00; B04C 11/00; B04C 2003/006; A47L 9/165; A47L 9/1683; A47L 9/1608

(57) ABSTRACT

A cyclone type dust collecting apparatus according to an exemplary embodiment of the claimed disclosure includes a collection container having a tubular shape extending in a front-rear direction, the collection container including a front end surface and a rear end surface, an inflow portion into which air flows, the inflow portion being connected to a peripheral surface of the collection container, and an inner cylinder that penetrates the rear end surface, a portion of the inner cylinder being disposed inside the collection container. In the cyclone type dust collecting apparatus, the inner cylinder includes, at a peripheral surface in a portion positioned inside the collection container, an outlet through which the air flows out, the rear end surface has a width that is larger than that of the front end surface, and the inflow portion is disposed unevenly on a front side.

### CROSS REFERENCE TO RELATED APPLICATIONS

This application claims the benefit of priority to Japanese Patent Application No. 2015-230230 filed on Nov. 26, 2015 and is a Continuation Application of PCT Application No. PCT/JP2016/083741 filed on Nov. 15, 2016. The entire contents of each application are hereby incorporated herein by reference.

### BACKGROUND OF THE INVENTION

### 1. Field of the Invention

The present disclosure relates to a cyclone type dust collecting apparatus.

### 2. Description of the Related Art

Hitherto, an electric vacuum cleaner in which a cyclone type dust collecting mechanism is used in a horizontal posture has been proposed.

The cyclone type dust collecting mechanism includes a substantially cylindrical-shaped main dust collecting chamber and a sub dust collecting chamber formed adjacent to a peripheral lateral surface of the main dust collecting chamber. Furthermore, one side of each of the main dust collecting chamber and the sub dust collecting chamber in the longitudinal direction is open. Furthermore, the main dust collecting chamber and the sub dust collecting chamber are in communication with each other through a communication hole provided near bottoms on the opposite side of the openings. The openings of the main dust collecting chamber and the sub dust collecting chamber are covered by a dust collection cover. The dust collection cover is provided with a cylinder that is positioned at a center portion of the main dust collecting chamber when the opening is covered with the dust collection cover. Furthermore, an air intake is provided in the peripheral lateral surface of the main dust collecting chamber.

In the cyclone type dust collecting mechanism, the airflow forming a vortex inside the main dust collecting chamber moves in a longitudinal direction of the main dust collecting chamber and moves towards the bottom of the main dust collecting chamber. Furthermore, the flowing air forming a vortex flows out to the outside of the dust collecting case through a front edge of the cylinder and through the cylinder. The flow of the air changes from a vortex forming flow to a flow that passes the cylinder from the front edge of the cylinder. In so doing, dust is separated from the air. The separated dust moves to the sub dust collecting chamber through the communication hole formed near the bottom of the main dust collecting chamber and is accumulated in the sub dust collecting chamber.

The cyclone type dust collecting mechanism includes the sub dust collecting chamber formed adjacent to the peripheral lateral surface of the substantially cylindrical-shaped main dust collecting chamber. Furthermore, the cyclone type dust collecting mechanism is configured so that the air drawn in through the air intake flows while forming a vortex inside the main dust collecting chamber. Accordingly, the main dust collecting chamber needs to be large enough to allow the dust to be separated. Furthermore, the sub dust collecting chamber needs to be provided at the peripheral lateral surface of the main dust collecting chamber, and there is a limit to the extent to which the cyclone type dust collecting mechanism can be reduced in size while maintaining the dust collecting efficiency.

### SUMMARY OF THE INVENTION

An exemplifying cyclone type dust collecting apparatus of the present disclosure includes a collection container having a tubular shape extending in a front-rear direction, the collection container including a front end surface and a rear end surface, an inflow portion into which air flows, the inflow portion being connected to a peripheral surface of the collection container, and an inner cylinder that penetrates the rear end surface, a portion of the inner cylinder being disposed inside the collection container. In the cyclone type dust collecting apparatus the inner cylinder includes, at a peripheral surface in a portion disposed inside the collection container, an outlet through which the air flows out, the rear end surface has a width that is larger than that of the front end surface, and the inflow portion is disposed unevenly on a front side.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a cyclone type dust collecting apparatus according to an exemplifying embodiment of the present disclosure.

FIG. 2 is an exploded perspective view of the cyclone type dust collecting apparatus illustrated in FIG. 1.

FIG. 3 is a cross-sectional view of the cyclone type dust collecting apparatus illustrated in FIG. 1 cut along line III-III.

FIG. 4 is a cross-sectional view of the cyclone type dust collecting apparatus illustrated in FIG. 3 cut along line IV-IV.

FIG. 5 is a cross-sectional view of the cyclone type dust collecting apparatus illustrated in FIG. 3 cut along line V-V.

FIG. 6 is a cross-sectional view of an enlarged extension silencer of the cyclone type dust collector according to an exemplifying embodiment of the present disclosure.

FIG. 7 is a drawing of a projection of the extension silencer illustrated in FIG. 6 in the axial direction.

FIG. 8 is a perspective view of a vacuum cleaner using the cyclone type dust collecting apparatus according to an exemplifying embodiment of the present disclosure viewed from under.

FIG. 9 is a cross-sectional view of the vacuum cleaner illustrated in FIG. 8.

FIG. 10 is a perspective view illustrating an installed state of the cyclone type dust collecting apparatus illustrated in FIG. 8.

### DETAILED DESCRIPTION OF THE PREFERRED EMBODIMENTS

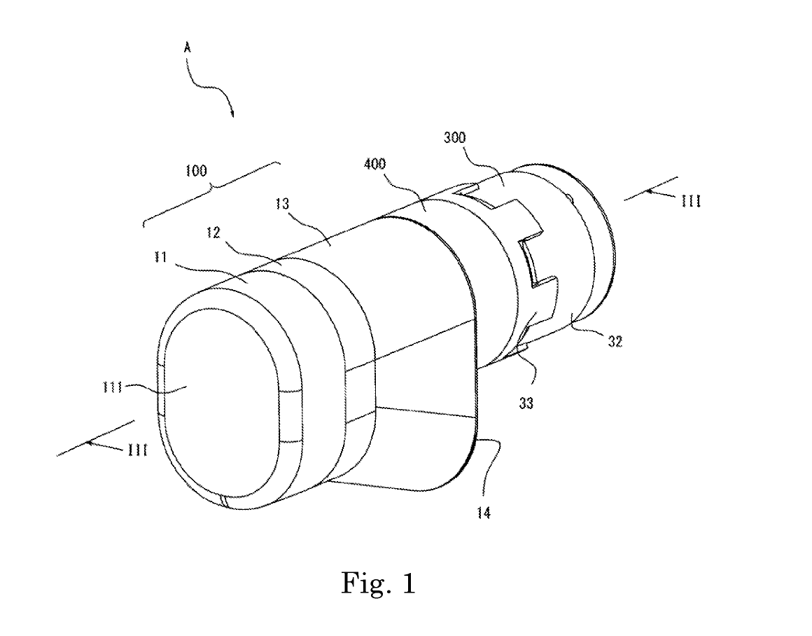

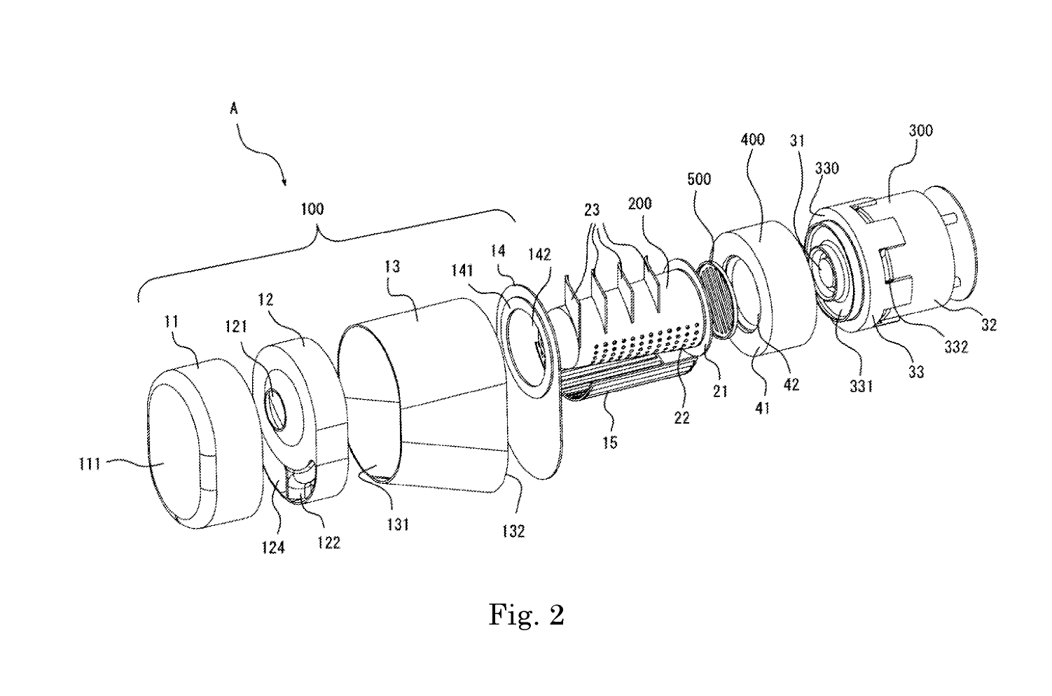

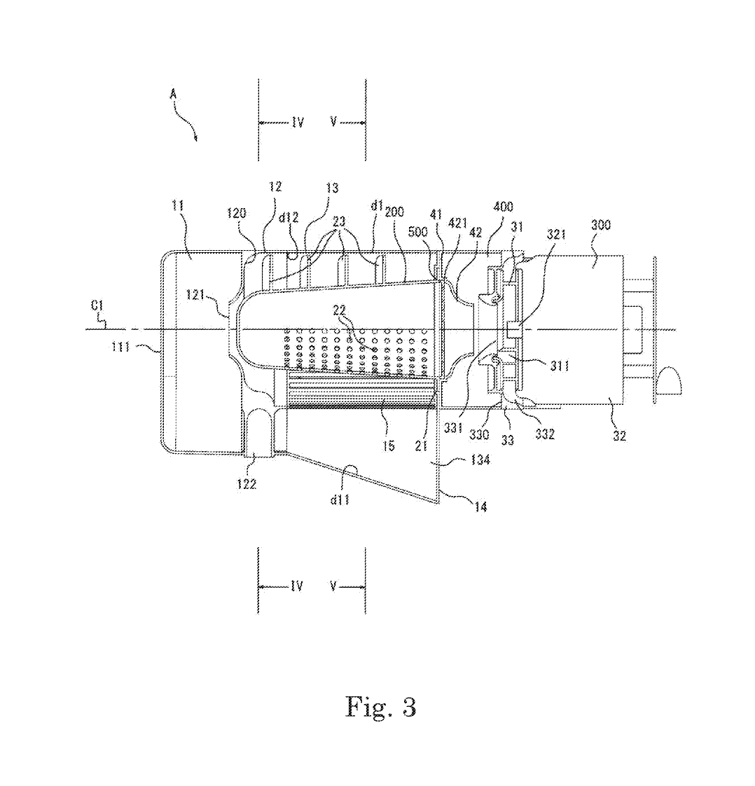

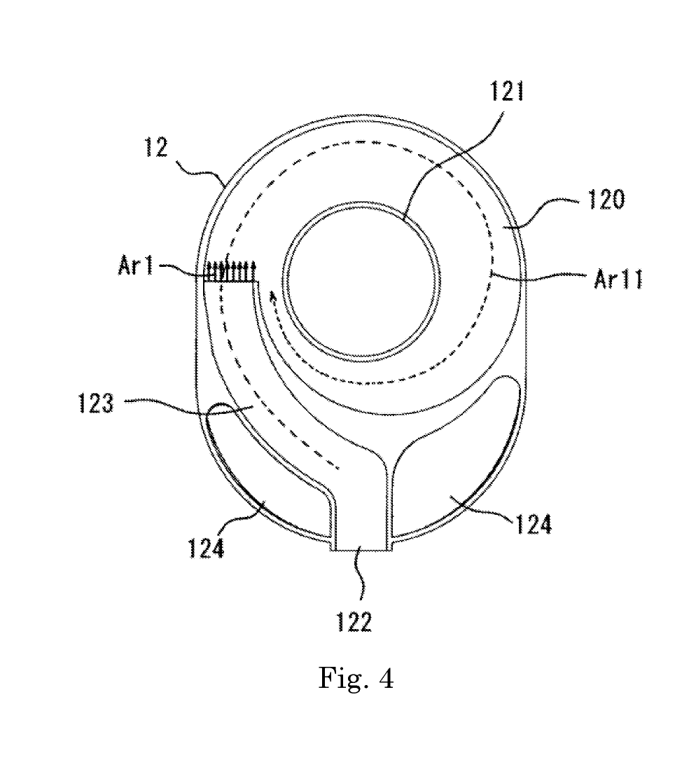

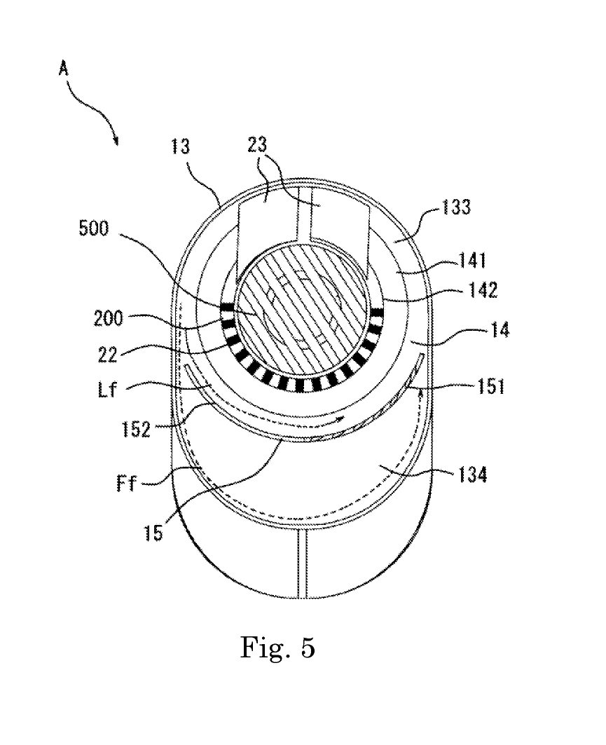

Hereinafter, exemplary embodiments of the present disclosure will be described with reference to the drawings. FIG. 1 is a perspective view of a cyclone type dust collecting apparatus according to the present disclosure. FIG. 2 is an exploded perspective view of the cyclone type dust collecting apparatus illustrated in FIG. 1. FIG. 3 is a cross-sectional view of the cyclone type dust collecting apparatus illustrated in FIG. 1 cut along line III-III. FIG. 4 is a cross-sectional view of the cyclone type dust collecting apparatus illustrated in FIG. 3 cut along line IV-IV. FIG. 5 is a cross-sectional view of the cyclone type dust collecting apparatus illustrated in FIG. 3 cut along line V-V.

Note that in the following description, an axial direction of an inner cylinder of a cyclone type dust collecting apparatus A is defined as the front-rear direction. Furthermore, as illustrated in the FIG. 3, in the horizontal direction, the left side in the front-rear direction is defined as the front. Furthermore, the vertical direction when the cyclone type dust collecting apparatus A is disposed in the direction illustrated in FIG. 3 is defined as the up-down direction. Moreover, the left and right are defined relative to the front of the cyclone type dust collecting apparatus A illustrated in FIG. 3. In the following description, shapes and positional relationships of the parts will be described using the front-rear direction, the left-right direction, and the up-down direction. However, the definitions of the directions are not intended to limit the direction of the cyclone type dust collecting apparatus according to the present disclosure.

As illustrated in FIGS. 1 and 2, the cyclone type dust collecting apparatus A according to the present embodiment includes a collection container 100, an inner cylinder 200, a blower 300, a sleeve 400, and a dust collecting mesh 500. The blower 300 is connected to a rear side end portion of the collection container 100. The sleeve 400 has a cylindrical shape and is open at both ends. A front side end portion of the sleeve 400 is connected to a dust collection cover 14 (described later) of the collection container 100. A rear side end portion of the sleeve 400 is connected to a cover 33 (described later) of the blower 300. In other words, a first end of the sleeve 400 is connected to the collection container 100 and a second end thereof is connected to the blower 300.

A front side portion of the inner cylinder 200 is disposed inside the collection container 100. Furthermore, the dust collecting mesh 500 is disposed in the flange 21 (described later) of the inner cylinder 200 and an air outlet 42 (described later) of the sleeve 400.

The collection container 100 includes a front lid 11, an air intake member 12, a swirl cylinder 13, and the dust collection cover 14. In the collection container 100, the front lid 11, the air intake member 12, the swirl cylinder 13, and the dust collection cover 14 are connected in the front-rear direction in that order. Furthermore, a partition member 15 that partitions a portion of the swirl cylinder 13 is disposed inside the swirl cylinder 13.

The front lid 11 has a cylindrical shape with a bottom and a bottom surface 111 constitutes a front end surface. As illustrated in FIGS. 1 and 2, the bottom surface 111 of the front lid 11 has an oval shape. However, the shape is not limited to the above. The shape of the bottom surface 111 may be a round shape, an elliptical shape, or an oval shape. Furthermore, it may be a combined shape of a semicircle and a semi-ellipsoid. The shape of the bottom surface 111 is a shape that corresponds to the shape of the collection container 100.

In the front lid 11, a side opposite to the bottom surface 111 is open, and an opening thereof is detachably attached to the air intake member 12. While details will be described later, the front lid 11 is opened and closed when discarding the dust collected in the cyclone type dust collecting apparatus A. The front lid 11 is attached to and detached from the air intake member 12; however, the configuration is not limited to the above. For example, the front lid 11 may include a hinge-shaped opening and closing mechanism or the front lid 11 may be configured so that a portion of the front lid 11 is opened and closed. Any configuration that can discharge the dust accumulated inside to the outside can be widely employed.

The air intake member 12 takes air into the collection container 100 and controls the flow of the air. In the air intake member 12, a front side end surface is connected to the front lid 11 and a rear side end surface is connected to the swirl cylinder 13. Note that the air intake member 12 and the front lid 11, and the air intake member 12 and the swirl cylinder 13 are in contact with each other so that air does not leak therefrom, in other words, are in contact with each other in an airtight manner.

As illustrated in FIG. 2 and the like, a cross-sectional shape of the air intake member 12 cut along a plane orthogonal to the front-rear direction has the same shape as a cross section of the front lid 11 cut along the same manner. In other words, the air intake member 12 has an oval shape when viewed in the front-rear direction. Note that similar to the front lid 11, the air intake member 12 can also have a round shape, an elliptical shape, a combined shape of a semicircle and a semi-ellipsoid, or the like. Furthermore, the outer peripheral shapes of the front lid 11 and the air intake member 12 may be made different intentionally. By so doing, a step is formed at the boundary portion between the front lid 11 and the air intake member 12. The front lid 11 can be easily detached by hooking the step with a finger.

The air intake member 12 includes a recess 120, a penetration port 121, an inflow portion 122, an introduction passage 123, and discharge ports 124. The recess 120 is formed in a rear side end surface of the air intake member 12. A cross section of the recess 120 cut along a plane orthogonal to the front-rear direction has a substantially round shape. The recess 120 has a cylindrical shape extending in the axial direction (herein, a central axis C1 direction). Furthermore, the recess 120 has a closed surface on the side (herein, the front side), in other words, on the side opposite to the opening in the axial direction. In the description hereinafter, a portion including the surface of the recess 120 on the rear side will be referred to as a bottom portion of the recess 120. The center of the bottom portion of the recess 120 is above the center of the air intake member 12 in the major axis direction (the up-down direction). The center of the bottom portion of the recess 120 overlaps the central axis C1 (described later) of the inner cylinder 200 in the up-down direction.

As illustrated in FIG. 3, the bottom surface of the recess 120 protrudes towards the front side, in other words, towards the front lid 11 side. Furthermore, the penetration port 121 is formed at the center of the protruded portion. In other words, the penetration port 121 that penetrates in the front-rear direction is formed at the center portion of the bottom surface of the recess 120. While the details will be described later, the penetration port 121 is an opening through which the dust remaining inside the swirl cylinder 13 moves to the front lid 11. Note that the recess 120 does not have to be protruded to the front side and may be planar.

The inflow portion 122 is an opening through which the air flows into the collection container 100. The inflow portion 122 is connected to an outer peripheral surface of the air intake member 12 on the side opposite to the recess 120 in the major axis direction. As illustrated in FIGS. 2 and 4, the inflow portion 122 has a tubular shape that extends upwards towards the inner side from a lower end of the air intake member 12. A first end portion of the inflow portion 122 protrudes external to the air intake member 12. A second end portion of the inflow portion is connected to the introduction passage 123.

The introduction passage 123 is a duct that connects the inflow portion 122 and the recess 120 to each other. The introduction passage 123 has a tubular shape extending along an inner surface of the recess 120. The air taken in through the inflow portion 122 passes through the introduction passage 123 and flows into the recess 120. The air that has passed though the introduction passage 123 and that has been blown out to the recess 120 flows along the inner surface of the recess 120.

The discharge ports 124 are formed in the air intake member 12 and on the side opposite to the recess 120 in the major axis direction, in other words, at the lower portion in FIG. 2. The discharge ports 124 are openings for the dust accumulated inside the swirl cylinder 13 to move to the front lid 11. The detail in which the dust is moved to the front lid 11 from the swirl cylinder 13 will be described later. Note that in the present embodiment, while two discharge ports 124 are provided in the air intake member 12, it may be conceived as the inflow portion 122 traversing a single discharge port 124. Furthermore, in a case in which the inflow portion 122 is connected along the air intake member 12, the number of discharge ports 124 may be one. The number and the shape of the discharge ports 124 are not limited to any number and shape as long as the shape and the area that allow the dust to move to the front lid 11 are obtained.

The swirl cylinder 13 is a member having a cylindrical shape extending in the front-rear direction. Air flows into the swirl cylinder 13 through the air intake member 12. Inside the swirl cylinder 13, the air that has flowed therein flows along an inner surface. Furthermore, the flow of the air (hereinafter, may be referred to as an airflow) that has flowed therein moves to the rear side from the front side while swirling inside the swirl cylinder 13. In other words, the airflow flows inside the swirl cylinder 13 in a spiral manner.

The swirl cylinder 13 includes a front side opening 131 and a rear side opening 132. A front end of the swirl cylinder 13 is connected to the air intake member 12. The dust collection cover 14 that covers an end portion opening 132 is attached to a rear end of the swirl cylinder 13. While the front side opening 131 and the rear side opening 132 are end surfaces of the swirl cylinder 13 cut along planes that are orthogonal to the front-rear direction, the front side opening 131 and the rear side opening 132 are not limited to the above. The surfaces in which the front side opening 131 and the rear side opening 132 are included may, with respect to the front-rear direction, be at an angle other than a right angle. However, in order to suppress unnecessary resistance against the flow of the air, it is desirable that the front side opening 131 and the rear side opening 132 have shapes cut along planes orthogonal to the front-rear direction.

The front side opening 131 of the swirl cylinder 13 has the same shape and area as those of the end portion on the downstream side of the air intake member 12. In other words, the front side opening 131 of the swirl cylinder 13 has an oval shape when viewed in the front-rear direction. Note that similar to the front lid 11 and the air intake member 12, the front side opening 131 of the swirl cylinder 13 can have a round shape, an elliptical shape, a combined shape of a semicircle and a semi-ellipsoid, or the like. In the swirl cylinder 13, the front side opening 131 is covered by the air intake member 12. Accordingly, in a case in which the shapes and the sizes of the rear side end surface of the air intake member 12 and the front side opening 131 of the swirl cylinder 13 are different, the rear side end surface of the air intake member 12 is larger than the front side opening 131 of the swirl cylinder. Note that the swirl cylinder 13 and the air intake member 12 may be separable or may be fixed to each other. By being separable, cleaning and the like inside the swirl cylinder 13 are facilitated.

The front side opening 131 and the rear side opening 132 of the swirl cylinder 13 both have an oval shape extending in the up-down direction. Furthermore, compared to the front side opening 131, the rear side opening 132 is large.

The inner cylinder 200 and the partition member 15 are disposed inside the swirl cylinder 13. As illustrated in FIG. 3, the central axis C1 of the inner cylinder 200 is parallel to the front-rear direction. Furthermore, the cyclone type dust collecting apparatus A illustrated in FIG. 3 is a cross section cut along a plane that passes the central axis C1 of the inner cylinder 200 and that is parallel to the up-down direction. The cross section of the swirl cylinder 13 in FIG. 3 is referred to as a cross section dl. The cross section dl includes, with the inner cylinder 200 in between, a first side d11 on the lower side and a second side d12 on the upper side.

As illustrated in FIG. 3, the cross section dl is trapezoidal. The first side d11 is inclined against the central axis C1 of the inner cylinder 200. Regarding distances of the first side d11 from the center of the inner cylinder 200, the rear side is longer than the front side. Meanwhile, the second side d12 is parallel to the central axis C1 of the inner cylinder 200. As illustrated in FIG. 3, the width of the cross section dl on the rear side expands downwardly. In other words, the swirl cylinder 13 has a shape in which the upper edge is parallel to the front-rear direction and in which, in the lower edge, the width of the rear side widens downwardly in the front-rear direction. As illustrated in FIGS. 2 and 3, cross-sectional shapes of an upper portion of the swirl cylinder 13 cut along planes orthogonal to the front-rear direction at any point in the front-rear direction are the same. Furthermore, cross-sectional shapes of a lower portion of the swirl cylinder 13 cut along planes orthogonal to the front-rear direction are shapes that change in the front-rear direction. Note that in the swirl cylinder 13 illustrated in the present embodiment, a cross section of an inner surface of the upper portion has a semi-circular cylindrical shape. Furthermore, the semi-circular portion of the inner surface of the upper portion of the swirl cylinder 13 has the same radius of curvature as that of the inner surface of the recess 120 of the air intake member 12.

The swirl cylinder 13 illustrated above is an example and the swirl cylinder 13 is not limited to the above. The cross-sectional shape of the inner surface of the swirl cylinder 13 cut along a plane that is orthogonal to the front-rear direction at any point in the front-rear direction may be an elliptical shape or may be a combined shape of a semicircle and a semi-ellipsoid. Furthermore, the above is only an exemplification, and the cross-sectional shape is not limited to the above. The cross-sectional shape of the inner surface of the swirl cylinder 13 cut along a plane orthogonal to the front-rear direction is desirably a differentiable shape across the entire periphery. In other words, the cross-sectional shape is desirably a continuously smooth shape across the entire periphery. By giving such a differentiable shape, the flow of the air swirling on the inner surface of the swirl cylinder 13 is not disturbed easily. With the above, the flow of the air does not easily become a turbulent flow, and the dust becomes separated more easily with centrifugal force. Note that the separation of the flow of the air that has flowed in and the dust included in the air will be described later. Note that the configuration may be such that a protrusion, a recess, or the like is provided intentionally on the inner surface of the swirl cylinder 13 with the objective other than rectification of the flow of the air and separation of the dust.

The partition member 15 is provided inside the swirl cylinder 13. The partition member 15 vertically divides the inside of the swirl cylinder 13. The partition member 15 has a shape of a cylinder cut at a uniform interval in the circumferential direction. An inner side of the partition member 15 in the bending direction has the same curvature as that of the inner surface of the recess 120 of the air intake member 12. As illustrated in FIGS. 3 and 5, the partition member 15 partitions the swirl cylinder 13 into an inner peripheral area 133 at the upper portion and an accumulation area 134 at the lower portion. The inner cylinder 200 is disposed in the inner peripheral area 133. The accumulation area 134 is a space where the dust included in the air that has flowed inside the swirl cylinder 13 is accumulated.

As illustrated in FIG. 5, the partition member 15 includes a ventilating portion 151 and an air guiding portion 152. The ventilating portion 151 is provided with a hole through which the airflow can pass in a radial direction. Note that the ventilating portion 151 illustrated in FIGS. 2, 5, and the like has a slit shape extending in the axial direction of the partition member 15; however, the shape is not limited to the above. For example, the ventilating portion 151 may be one formed with innumerable through holes each having a cross section that is circular, elliptic, polygonal, or the like. Furthermore, regarding the ventilating portion 151, a large through hole may be formed and a net (mesh) may be attached thereto so as to cover the through hole. The ventilating portion 151 can widely adopt any size and shape that does not pass dust therethrough while air passes therethrough.

Furthermore, the air guiding portion 152 is a guide that guides the airflow flowing inside the swirl cylinder 13 in a swirling direction. In the air guiding portion 152, the airflow flows in the circumferential direction.

Accordingly, the air guiding portion 152 has a shape in which a plate with no penetration in a thickness direction is bent. While guiding the flow of the air, the partition member 15 suppresses the dust accumulated in the accumulation area 134 from being whirled up. In the partition member 15, the upstream side of the airflow swirling inside the swirl cylinder 13 is the air guiding portion 152, and the downstream side is the ventilating portion 151. Details of the effect of the partition member 15 will be described later.

The dust collection cover 14 covers the rear side opening 132 of the swirl cylinder 13. Note that the dust collection cover 14 is detachable from the swirl cylinder 13. The dust collection cover 14 is in contact with the rear side opening 132 of the swirl cylinder 13 in an airtight manner. The dust collection cover 14 is a plate-shaped member and includes a press portion 141 and a through hole 142. The press portion 141 protrudes towards the swirl cylinder 13 side. The press portion 141 has an inner surface with a cylindrical shape, and the flange 21 (described later) of the inner cylinder 200 is disposed thereon. The through hole 142 is a round-shaped opening. The inner cylinder 200 penetrates the through hole 142. While the details will be described later, the angle at which the inner cylinder 200 is disposed with respect to the swirl cylinder 13 is determined. Accordingly, positioning portions that determine the angle of the inner cylinder 200 may be provided on the flange 21 of the inner cylinder 200 and the press portion 141 of the dust collection cover 14. The positioning portions can include a configuration in which the angle is determined by fitting and a configuration in which the shapes of the press portion 141 and the flange 21 are shapes other than a circle, such as an elliptic shape, a polygonal shape, and the like. Furthermore, other than the above, positioning portions capable of accurately determining the angle can be widely employed.

The inner cylinder 200 has a closed front end and has a cylindrical shape extending in the front-rear direction. The inner cylinder 200 having the central axis C1 coinciding a central axis of the recess 120 of the air intake member 12 is disposed inside the swirl cylinder 13. The air that has flowed into the swirl cylinder 13 flows out to the outside after flowing into the inner cylinder 200. A cross section of the inner cylinder 200 cut along a plane orthogonal to the front-rear direction has a round shape.

Compared with the rear side, the front side of the inner cylinder 200 has a small diameter. The inner cylinder 200 serves as a guide that swirls the flow of the air that has flowed in from the air intake member 12. Furthermore, the inner cylinder 200 also serves to flow the air that has flowed into the swirl cylinder 13 to the outside of the swirl cylinder 13. Note that the inner cylinder 200 is not limited to the above shape. For example, the inner cylinder 200 may have a shape having the same diameter at the front and at the rear.

The flange 21 and outlets 22 are formed in the inner cylinder 200. Furthermore, straightening plates 23 are provided on an outer peripheral surface of the inner cylinder 200. In the inner cylinder 200, the rear end is open. The flange 21 is provided on an outer peripheral surface of an opening of the inner cylinder 200, and has a tabular shape extending outwards in the radial direction of the inner cylinder 200. The flange 21 has a shape that fits in the press portion 141 of the dust collection cover 14. In the flange 21, the front surface is pressed by (the press portion 141 of) the dust collection cover 14, and the rear surface is pressed by the sleeve 400. With the above, the movement and looseness of the inner cylinder 200 in the front-rear direction are suppressed.

The outlets 22 are formed in the inner cylinder 200 at a portion that is positioned inside the swirl cylinder 13. The outlets 22 are through holes that penetrate an outer surface and an inner surface of the inner cylinder 200. The air inside the swirl cylinder 13 passes through the outlets 22, flows into the inner cylinder 200, and, subsequently, flows out through the rear end. As illustrated in FIG. 3, the outlets 22 are disposed on a rear side of the inner cylinder 200. In other words, the outlets 22 are disposed unevenly on a rear end surface (the dust collection cover 14) side of the inner cylinder 200. By forming the outlets 22 on the rear side in the above manner, the air that has flowed out from the introduction passage 123 does not become a swirling flow and is suppressed from being directly discharged from the outlets 22. Note that the position where the outlets 22 are formed may include a position on the rear side with respect to the portion where the air has turned into a stable swirling flow.

The inner cylinder 200 also functions to stop the dust inside the swirl cylinder 13 from flowing out to the outside. For example, in the swirl cylinder 13, a lot of dust flows into the accumulation area 134 with the operation described later and remains in the accumulation area 134. On the other hand, there are cases in which dust that swirls inside the inner peripheral area 133 without flowing into the accumulation area 134 is generated.

In order to suppress discharge of dust to the outside, in the inner cylinder 200 of the present embodiment, the outlets 22 are configured so that through holes that are smaller than the external shape of the dust are provided in plural numbers. With the above, the outlets 22 can make the air flow out smoothly. Furthermore, the outlets 22 suppresses the dust from flowing out to the outside of the swirl cylinder 13. Note that when the inner cylinder 200 is disposed inside the swirl cylinder 13, the outlets 22 are provided in an underside of the inner cylinder 200. By providing the outlets 22 on the underside in the above manner, when the airflow stops, the dust that had been drawn to the outlets side with the airflow falls below the inner cylinder 200. Furthermore, an upper side of the inner cylinder 200 guides the airflow in the swirling direction.

Note that the outlets 22 illustrated in FIGS. 2, 3, and others are arranged at uniform intervals in the circumferential direction and in the axial direction. However, the arrangement is not limited to the above. For example, when there is a portion where the pressure of the air is high and a portion where the pressure is low in the circumferential direction of the inner cylinder 200 due to the flow of the air, the arrangement of the outlets 22 may be determined in accordance with the pressure distribution. The configuration in which the air flowing in through the inflow portion 122 of the air intake member 12 is made to flow out can be widely employed.

Furthermore, while a plurality of round-shaped through holes are arranged as the outlets 22, the outlets 22 are not limited to the above. For example, the outlets 22 may be slit-shaped holes extending in the axial direction, strip-like holes each having a predetermined length in the circumferential direction, and the like. The configuration of the openings in which the air that have flowed inside the swirl cylinder 13 flows into the inner cylinder 200 can be widely employed. As above, in a case in which the outlets 22 are slit shaped or are strip like, a net-like (mesh-like) member is attached. With the above, the dust can be suppressed from passing therethrough.

The straightening plates 23 are attached on the outer side of the inner cylinder 200. The straightening plates 23 are attached to an upper portion of the inner cylinder 200. Furthermore, on the downstream side of the airflow that flows in a swirling manner, the straightening plates 23 are displaced to the rear side with respect to a plane orthogonal to the central axis C1 of the inner cylinder 200. By having the straightening plates 23 be provided in such a manner, the airflow flowing between an upper portion of the inner surface of the swirl cylinder 13 and an upper surface of the inner cylinder 200 is rectified towards the rear side. With the above, the airflow flows inside the swirl cylinder 13 in a spiral manner in the front-rear direction.

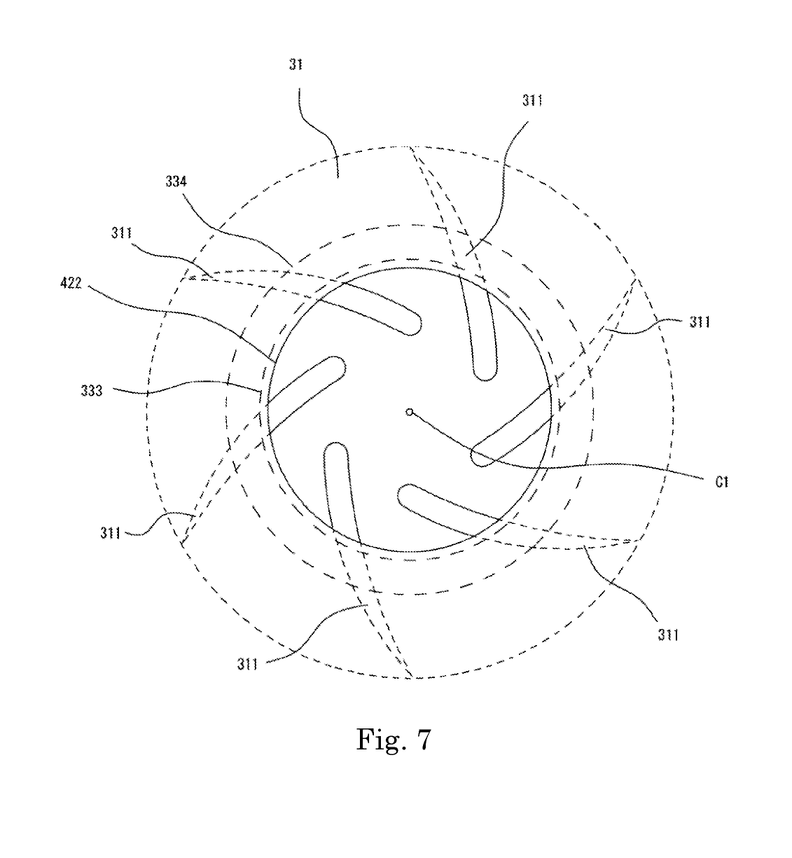

The blower 300 is a blowing device that generates an airflow suctioned in the axial direction. Herein, the blower 300 is a centrifugal fan. With the above, a large negative pressure can be generated with the centrifugal fan. The blower 300 includes a vane wheel 31, an electric motor 32, and the cover 33. The electric motor 32 generates torque with the power of electricity. Herein, it is a motor. The electric motor 32 includes an output shaft 321. By supplying electric power to the electric motor 32, the output shaft 321 is rotated in the circumferential direction. The vane wheel 31 generates a flow of air. Herein the vane wheel 31 is a centrifugal impeller (a turbo impeller, for example) in which impellers 311 that extend radially are arranged in the circumferential direction (see FIG. 7 described later). However, not limited to the above, a member that has a shape that generates an airflow mat be widely employed. In the blower 300, the vane wheel 31 is attached to the output shaft 321. The vane wheel 31 rotates around a central axis of rotation of the blower 300. In other words, the vane wheel 31 rotates about the central axis of rotation of the blower 300.

The cover 33 includes a round and planar front wall portion 330 on the front side and has a cylindrical shape that extends towards the rear side. The cover 33 includes an inlet 331 and a discharge portion 332. The inlet 331 is provided in the front wall portion 330 and includes an opening that penetrates the front wall portion 330. In other words, the cover 33 includes the inlet 331 that opens in a direction of the central axis of rotation. Furthermore, the inlet 331 includes a projection that extends outwardly and that projects in a columnar manner. The discharge portion 332 is an opening through which the air in the cover 33 is discharged with the rotation of the vane wheel 31.

The cover 33 is attached by being fitted to an outside of a motor case 322 that is an exterior of the electric motor 32. The cover 33 covers the vane wheel 31 attached to the output shaft 321. In other words, the cover 33 surrounds the vane wheel 31. In other words, the blower 300 includes the vane wheel 31 that rotates about the central axis of rotation and the cover 33 that surrounds the vane wheel 31. In the above, a center of an opening of the inlet 331 overlaps the central axis of rotation of the blower 300. By providing the opening of the inlet 331 so that the center thereof overlaps the central axis of the blower 300, the air can be suctioned efficiently. However, not limited to the above, the central axis of rotation of the blower 300 and the center of the opening can be somewhat misaligned with each other but it is desirable that the central axis of rotation be positioned at the opening. In other words, when projected in the direction of the central axis of rotation, the central axis of rotation of the blower 300 is desirably disposed inside the inlet 331. Pressure loss can be suppressed with the above.

In the blower 300, by supplying electric power to the electric motor 32, the output shaft 321 rotates. The vane wheel 31 is rotated by the rotation of the output shaft 321. By having the vane wheel 31 rotate, air is blown out from the discharge portion 332 and air is suctioned through the inlet 331. With the above, air flows in through the inflow portion 122 of the air intake member 12. The blower 300 has a configuration that is the same as those of conventionally used blowing devices and detailed description thereof is omitted.

The sleeve 400 has a cylindrical shape that extends towards the front and rear. The sleeve 400 includes a front edge surface 41 at the front side end portion. An opening is provided at a center portion of the front edge surface 41. In other words, the sleeve 400 has a cylindrical shape open at both ends. An air outlet 42 that extends rearwards from a side edge portion of the opening of the front edge surface 41 is provided. An inside diameter of the air outlet 42 becomes smaller towards the rear side. Pressure loss is reduced by providing the air outlet 42. Note that the air outlet 42 herein is a bellmouth. However, the air outlet 42 is not limited to the above.

A recess 421 is provided in the air outlet 42 to dispose the dust collecting mesh 500. Note that while the air outlet 42 is provided in the sleeve 400, not limited to the above, the air outlet 42 may be provided in the inner cylinder 200. Furthermore, the air outlet 42 may be a cylindrical shape. The sleeve 400 and the cover 33 constitute an extension silencer described later.

The shape of the plane of projection of the sleeve 400 in the front-rear direction coincides with the shape of the plane of projection of the front wall portion 330 of the cover 33 of the blower 300 in the front-rear direction. In other words, a rear end portion of the sleeve 400 coincides with the front wall portion 330 of the cover 33 in the axial direction and is adhered in an airtight manner.

The dust collecting mesh 500 includes a filter that collects the dust included in the air flowing out from the inner cylinder 200. In the inner cylinder 200, passage of dust is suppressed with the outlets 22. However, there are cases in which the air flowing in from the air intake member 12 include micro dust that has a size that cannot be separated with the collection container 100. Such dust passes through the ventilating portion 151 of the partition member 15 and the outlets 22 and is discharged to the outside of the inner cylinder 200 together with the airflow. The filter included in the dust collecting mesh 500 collects such micro dust.

Referring to the diagrams, details of the cyclone type dust collecting apparatus A will be described next. As illustrated in FIG. 3, in the collection container 100, the air intake member 12 is attached to the front end of the swirl cylinder 13. In the above, the front side opening 131 is covered by a portion other than the penetration port 121 and the discharge ports 124. Furthermore, the front lid 11 is attached to the front side of the air intake member 12. The front side of the air intake member 12 is covered by the front lid 11. The front lid 11 and the air intake member 12, and the air intake member 12 and the front end of the swirl cylinder 13 are adhered to each other. Accordingly, no air leaks from the boundary portions between the front lid 11 and the air intake member 12 and between the air intake member 12 and the front end of the swirl cylinder 13.

Furthermore, the inner cylinder 200 is passed through the through hole 142 of the dust collection cover 14. In so doing, the flange 21 of the inner cylinder 200 fits into the press portion 141 of the dust collection cover 14, and the position of inner cylinder 200 with respect to the dust collection cover 14 is set. Furthermore, the straightening plates 23 are attached to the inner cylinder 200 that has passed through the through hole 142 of the dust collection cover 14. The partition member 15 is disposed inside the swirl cylinder 13. The front end of the partition member 15 is in contact with the air intake member 12. In the above, an inner surface of the partition member 15 in the bending direction overlaps the inner surface of the recess 120 in the front-rear direction.

The inner cylinder 200 is entered into the swirl cylinder 13, and the rear side opening 132 of the swirl cylinder 13 is covered with the dust collection cover 14. The dust collection cover 14 adheres to the rear end of the swirl cylinder 13. In the above, a portion of a front edge of the inner cylinder 200 on the front side enters into the recess 120. Furthermore, in the recess 120 and the swirl cylinder 13, the outlets 22 formed in the inner cylinder 200 are disposed on the underside of the inner cylinder 200. Furthermore, the straightening plates 23 are, inside the recess 120 and the swirl cylinder 13, disposed on the upper surface of the inner cylinder 200. In other words, the outlets 22 through which the air flows out are formed in the peripheral surface of the inner cylinder 200 at a position inside the collection container 100. In other words, the inner cylinder 200 includes outlets 22, through which air flows out, in the peripheral surface of the portion disposed inside the collection container 100.

With the above, leakage of air from the boundary between the dust collection cover 14 and the swirl cylinder 13 is suppressed. Furthermore, in the partition member 15, the front end is held between and fixed to the air intake member 12, and the rear end is held between and fixed to the dust collection cover 14.

Note that the partition member 15 is provided in the air intake member 12 and the dust collection cover 14 and is held by a holding tool (not shown). Furthermore, the partition member 15 may be held by the pressing force of the air intake member 12 and the dust collection cover 14. The collection container 100 is formed in the above manner.

As illustrated in FIG. 5, a gap having a size allowing the dust included in the airflow to pass is formed between an end portion of the partition member 15 on the air guiding portion 152 side and the inner surface of the swirl cylinder 13. Meanwhile, a gap having a size in which the dust cannot pass is formed between an end portion on the ventilating portion 151 side and the inner surface of the swirl cylinder 13. Note that the gap does not have to be formed. It is only sufficient that the configuration can suppress the dust from passing through.

As illustrated in FIG. 3, in the collection container 100, the central axis of the inner surface of the recess 120, the central axis of the inner surface of the upper portion of the swirl cylinder 13, the central axis of the inner surface of the partition member 15, and the central axis C1 of the inner cylinder 200 coincide each other. In other words, in the swirl cylinder 13, the inner peripheral area 133 on the upper side partitioned by the partition member 15 has a cylindrical shape having a central axis that is the same as the central axis C1. Furthermore, the accumulation area 134 is disposed below the inner peripheral area 133 of the swirl cylinder 13. As illustrated in FIG. 3, the inner cylinder 200 is disposed unevenly on the upper side inside the collection container 100.

In the cross section dl illustrated in FIG. 3, the inner cylinder 200 is provided unevenly on the second side d12 side. In other words, at least a portion of the inner cylinder 200 is, in the first cross section dl of the collection container 100, disposed unevenly on the second side d12 between the two sides d11 and d12 of the first cross section dl that oppose each other with the inner cylinder 200 in between. With the above, since the air passes the portion with a large diameter at the portion where the airflow is stable, collecting of the dust is facilitated. Note that in the present embodiment, the central axis C1 of the inner cylinder 200 is parallel to the front-rear direction; however, not limited to the above, the central axis C1 of the inner cylinder 200 may be inclined with respect to the front-rear direction. In such a case as well, the configuration is desirably such that at least a portion of the inner cylinder 200 is unevenly positioned on the second side d12 side.

The inside of the collection container 100 is formed in a tubular manner by having the front lid 11, the air intake member 12, and the swirl cylinder 13 be connected to each other. Furthermore, the bottom surface 111 of the front lid 11 is provided at the front side end portion of the collection container 100. Furthermore, the inner peripheral area 133 of the swirl cylinder 13 is connected to the recess 120 of the air intake member 12. The inner peripheral area 133 is connected to the front lid 11 with the penetration port 121 in between. Furthermore, the accumulation area 134 is connected to the front lid 11 with the discharge ports 124 in between. Furthermore, the dust collection cover 14 is provided at the rear side end portion of the collection container 100. In other words, the collection container 100 is tubular extending in the front-rear direction and includes the front end surface (the bottom surface 111) and the rear end surface (the dust collection cover 14).

Furthermore, the inflow portion 122 into which air flows is provided in the peripheral surface of the air intake member 12. In other words, the cyclone type dust collecting apparatus A is connected to the peripheral surface of the collection container 100 and includes the inflow portion 122 into which air flows. Note that while the inflow portion 122 is formed with the same member as that of the air intake member 12, the inflow portion 122 may be a separate member. In such a case, the inflow portion 122 is connected to the air intake member 12.

The inner cylinder 200 penetrates the through hole 142 of the dust collection cover 14. Furthermore, when the dust collection cover 14 is attached to the rear end of the swirl cylinder 13, the inner cylinder 200 is positioned inside the swirl cylinder 13. In other words, the inner cylinder 200 penetrates the rear end surface (the dust collection cover 14) and a portion thereof is disposed inside the collection container 100.

The bottom surface 111 of the front lid 11 has a shape that is the same as that of the front end of the swirl cylinder 13. Furthermore, the dust collection cover 14 covers the rear side opening 132 of the swirl cylinder 13. Furthermore, the rear end opening 132 of the swirl cylinder 13 is large when compared to the front end opening 131. Accordingly, the dust collection cover 14 is large compared to the bottom surface 111. In other words, the rear end surface (the dust collection cover 14) of the collection container 100 has a width that is wider than that of the front end surface (the bottom surface 111).

Furthermore, the air intake member 12 is disposed between the front lid 11 and the swirl cylinder 13. The inflow portion 122 is provided in the air intake member 12. In other words, the inflow portion 122 is disposed unevenly on the front side of the collection container 100. With the above, the cyclone type dust collecting apparatus A can be reduced in size without decreasing the dust collecting efficiency.

In FIG. 3, the cross section dl cut along a plane including the central axis C1 of the inner cylinder 200 includes the first side d11 and the second side d12 that oppose each other with the inner cylinder 200 in between. Furthermore, in the first side d11, the distance between the rear end and the central axis C1 is larger than the distance between the front end and the central axis C1. In other words, in the first cross section dl that is a cross section including the central axis C1 of the inner cylinder 200 of the collection container 100, between the two sides that oppose each other with the inner cylinder 200 in between, the first side d11 is a line that includes two points in which the distances to the central axis C1 are different. With the above, a reduction in size can be made without decreasing the dust collecting ability.

Note that while in the present embodiment, the first side d11 is a straight line, the first side d11 may be a curved line.

Furthermore, as illustrated in FIG. 3, the second side d12 of the cross section dl is parallel to the central axis C1 of the inner cylinder 200. In other words, the second side d12 of the first cross section dl is parallel to the central axis C1 of the inner cylinder 200. With the above, since the width on the second side d12 side does not become larger, the collection container can be reduced in size.

As illustrated in FIG. 3, the dust collection container 100 is disposed so that the front-rear direction is the horizontal direction, and the first side d11 is disposed at the lower portion in the up-down direction that is orthogonal to the front-rear direction. With the above, the accumulation area 134 accumulating the dust can be formed at the lower portion. Accordingly, when the airflow stops, the dust can be made to fall into the accumulation area 134.

As illustrated in FIGS. 2 and 3, the outlets 22 are disposed on the underside of the inner cylinder 200. In other words, in the cross section dl in FIG. 3, the outlets 22 are provided at a portion that opposed the first side d11. In other words, the outlets 22 are configured at a portion that opposes the first side d11 of the first cross section dl of the inner cylinder 200. With the above, when the airflow stops, the dust drawn to the inner cylinder 200 can be made to fall downwards.

The sleeve 400 is disposed so that the front edge surface 41 is in contact with the dust collection cover 14. The front edge surface 41 is adhered to the dust collection cover 14 and is adhered to the flange 21 of the inner cylinder 200. The flange 21 is pressed by the front edge surface 41. With the above, the inner cylinder 200 does not rotate and does not become loose. The recess 421 is provided in the air outlet 42 and the dust collecting mesh 500 is attached to the recess 421. The dust collecting mesh 500 is in close contact with the rear end of the inner cylinder 200. With the above, the air flowing out from the rear end of the inner cylinder 200 passes the dust collecting mesh 500.

As illustrated in FIG. 3, the inner wall surface of the sleeve 400 has a cylindrical shape that has the same inside diameter as that of the inner periphery of the inner peripheral area 133. The central axis C1 of the inner cylinder 200 and the central axis of the sleeve 400 coincide each other. The blower 300 is connected to the rear end of the sleeve 400.

The front wall portion 330 of the cover 33 is in contact with the rear end of the sleeve 400. In the above, the front wall portion 330 and the rear end of the sleeve 400 are adhered to each other. The plane of projection of the front wall portion 330 and that of the sleeve 400 in the front-rear direction have the same shape. Accordingly, by overlapping the sleeve 400 and the front wall portion 330 in the front-rear direction, the central axis of the sleeve 400 and the central axis of the blower 300 (the central axis of rotation) overlap each other. Note that by having the sleeve 400 be a member that is the same as that of the dust collection cover 14 or is the same as that of the cover 33, the blower 300 is connected to the rear side end portion of the collection container 100.

The front side end portion of the sleeve 400 is connected to the collection container 100. Furthermore, the rear side end portion of the sleeve 400 is connected to the blower 300. Furthermore, since the central axis of the sleeve 400 and the central axis of the inner cylinder 200 overlap each other, the central axis of the blower 300 and the central axis of the inner cylinder 200 overlap each other. In other words, when the blower 300 and the collection container 100 are connected to each other, the central axis C1 of the inner cylinder 200 and the central axis of the inlet 331 coincide each other. With the above, pressure loss can be reduced.

A dust collecting operation of the cyclone type dust collecting apparatus A according to the present disclosure will be described with reference to the diagrams. In the cyclone type dust collecting apparatus A, the collection container 100 and the blower 300 are connected to each other with the sleeve 400 interposed therebetween. Accordingly, by driving the blower 300 and drawing in the air through the inlet 331, the pressure inside the collection container 100 becomes negative. With the above, air is suctioned in through the inflow portion 122.

As illustrated in FIG. 4, the inflow portion 122 is in communication with the introduction passage 123. The air that has flowed in through the inflow portion 122 is guided by the introduction passage 123, and the air is blown out in a direction extending in a direction of the tangential line of the recess 120 (indicated by arrow Ar1 in FIG. 4). The airflow that has flowed into the recess 120 flows along the inner surface of the recess 120 (indicated by arrow Ar11 in FIG. 4). Note that the introduction passage 123 extends to an intermediate portion of the recess 120 in the up-down direction. By having the introduction passage 123 be configured in the above manner, the air that has flowed along the outer periphery of the recess 120 is suppressed from flowing back to the introduction passage 123. Furthermore, as illustrated in FIG. 3, the outlets 22 are not formed on the front end side of the inner cylinder 200. Accordingly, the inner surface of the recess 120 and the inner cylinder 200 serve as guides that swirl the flow of the air about the inner cylinder 200. As illustrated in FIG. 3, the straightening plates 23 are provided on the inner cylinder 200. The straightening plates 23 are provided in plural numbers, and one plate is disposed inside the recess 120. In other words, the airflow flowing along the side wall surface of the recess 120 flows along the straightening plates 23. By having the airflow flow along the straightening plates 23, a rearward component is added to the velocity component of the airflow. In other words, the flow of the air becomes spiral oriented from the front towards the rear about the inner cylinder 200 with the straightening plates 23.

Furthermore, the air flowing in a spiral manner flows into the swirl cylinder 13. Since the inner surface of the swirl cylinder 13 has an oval shape, with the centrifugal force, the spiral air flows along the inner surface of the swirl cylinder 13. The air that has flowed thereto includes dust, and the dust that is heavy compared to the air moves in a spiral manner while being pushed against the inner surface of the swirl cylinder 13.

The spiral flow of the air flows in the direction illustrated in FIG. 5. Note that the cross section illustrated in FIG. 5 is a cross section in which the rear side is viewed from the front side. The cross section illustrated in FIG. 4 is a cross section in which the front side is viewed from the rear side. Accordingly, in the drawings, the swirling directions of the airflow are opposite. In other words, the arrow Ar11 in FIG. 4, and the arrow Ff and the arrow Lf in FIG. 5 are extending in the opposite direction for each other. However, when referring to the central axis C1, the swirling directions are the same.

In the spiral flow of air inside the swirl cylinder 13, there is a portion that have a different flow velocity. In the description hereinafter, an airflow with high flow velocity is denoted as Ff, and an airflow with low flow velocity is denoted as Lf. Furthermore, the airflow Ff that has a fast flow velocity flow at a portion that is farther away from the inner cylinder. The airflow Lf that has a low flow velocity flows at a portion that is near the inner cylinder. Accordingly, the airflow Lf that has a slow flow velocity flows along the curved surface of the air guiding portion 152 on the inner cylinder 200 side. With the above, the airflow Lf that has a low flow velocity flows in the inner peripheral area 133 in a spiral manner.

Furthermore, the airflow Ff that has a high flow velocity flows in a spiral manner along the inner surface of the swirl cylinder 13. In other words, the airflow Ff passes through the gap (see FIG. 5) between the end portion of the partition member 15 on the air guiding portion 152 side and the swirl cylinder 13 and flows to the accumulation area 134. Together with the airflow Ff that has a high flow velocity, the dust pushed against the inner surface of the swirl cylinder 13 with centrifugal force also flows into the accumulation area 134. Furthermore, the airflow Ff that has a high flow velocity that has flowed in the accumulation area 134 passes through the ventilating portion 151 of the partition member 15 and flows into the inner peripheral area 133. When the airflow passes through the ventilating portion 151, the dust cannot pass through the ventilating portion 151. Accordingly, the dust is accumulated in the accumulation area 134. The dust that has flowed on the airflow Ff that has a high flow velocity in the above manner flows into the accumulation area 134 through the gap of the partition member 15.

Furthermore, when the blower 300 is driven, the pressure inside the inner cylinder 200 is low compared to that outside. Since the airflow Lf that has a low flow velocity is flowing near the inner cylinder 200, the force in the direction of the tangential line of the inner cylinder 200 is weak. Accordingly, due to the pressure difference between the inner surface and the outer surface of the inner cylinder 200, the air on the outer side of the inner cylinder 200 is drawn in through the outlets 22 to the inside of the inner cylinder 200. Furthermore, the airflow Ff that has a high flow velocity that has flowed to the rear side end portion of the swirl cylinder 13 in a spiral manner also flows into the inner cylinder 200 through the outlets 22.

As described above, the partition member 15 is provided with the air guiding portion 152 on the upstream side in the flow direction of the airflow and the ventilation portion 151 on the downstream side. With the above, the heavy dust can be accumulated in the accumulation area 134.

In the dust that has flowed inside the swirl cylinder 13, there are light ones as well. The light dust may flow on the airflow Lf that has a low flow velocity. The dust that has flowed on the airflow Lf that has a low flow velocity does not enter the accumulation area 134. Such dust stops at the outlets 22 when the airflow passes the outlets 22 of the inner cylinder 200 and is left behind in the swirl cylinder 13.

Dust of various sizes, large and small, are included in the air drawn into the cyclone type dust collecting apparatus A. Large dust is collected at the ventilating portion 151 of the partition member 15 or at the outlets 22. On the other hand, small (fine) dust is not collected at the ventilating portion 151 or the outlets 22 and enters into the inner cylinder 200. In the cyclone type dust collecting apparatus A, the air that has flowed into the inner cylinder 200 is sent to the dust collecting mesh 500 through the opening of the inner cylinder 200 at the rear portion. In the dust collecting mesh 500, the filter that collects the dust that cannot be collected at the ventilating portion 151 or the outlets 22 is attached. With the above, fine dust is also collected.

Note that the dust collecting mesh 500 is detachable from the sleeve 400 so that the filter can be replaced, cleaned, and the like. The air that has passed the dust collecting mesh 500 passes the air outlet 42 and is suctioned into the inlet 331 of the blower 300.

In the cyclone type dust collecting apparatus A, by driving the blower 300, air is suctioned through the inlet portion 122 and dust is accumulated inside the collection container 100. While the blower 300 is in operation, a spiral airflow is generated inside the collection container 100. In the above, the dust accumulated inside the accumulation area 134 of the collection container 100 flows on the airflow. With the above, the dust in the accumulation area 134 is suctioned to the ventilating portion 151 of the partition member 15. When the blower 300 is stopped, the airflow inside the collection container 100 stops. With the above, the dust suction to the ventilating portion 151 of the partition member 15 falls into the accumulation area 134.

In the cyclone type dust collecting apparatus A, when the dust accumulated in the collection container 100 is discarded, the collection container 100 is separated from the sleeve 400. Furthermore, by moving the front side of the collection container 100 downwards, the accumulation area 134 becomes connected to the front lid 11 through the discharge ports 124. Accordingly, by lowering the front side of the collection container 100, the dust accumulated in the accumulation area 134 moves to the front lid 11 through the discharge ports 124. Furthermore, there is dust that cannot pass through the inlet port 22 of the inner cylinder 200 in the inner peripheral area 133 as well. The dust moves to the front lid 11 through the penetration port 121. The front lid 11 is removed and the dust that has moved to the front lid 11 is discarded. As described above, in the cyclone type dust collecting apparatus A, the dust is collected, and the collected dust can be discarded easily. Furthermore, in the cyclone type dust collecting apparatus A according to the present embodiment, by disposing the inflow portion 122 on the front end surface side having a smaller cross section, an attaching space for an external device that is attached on the outer side of the inflow portion 122 can be obtained. The air that has flowed into the collection container 100 becomes rectified by flowing downstream. Accordingly, compared to the upstream side, the downstream side has a stable flow. Furthermore, the collection container 100 has a shape in which the width is wider downstream. With the above, since the radius of the swirling becomes large at the portion where the flow is stable, more dust can be sent to the accumulation area 134.

The cyclone type dust collecting apparatus A according to the present disclosure can suppress a decrease in the dust collecting ability that is the ability to collect dust and can reduce size. Accordingly, the degree of freedom of inner layout in devices that incorporate the cyclone type dust collecting apparatus A such as, for example, a vacuum cleaner, can be increased.

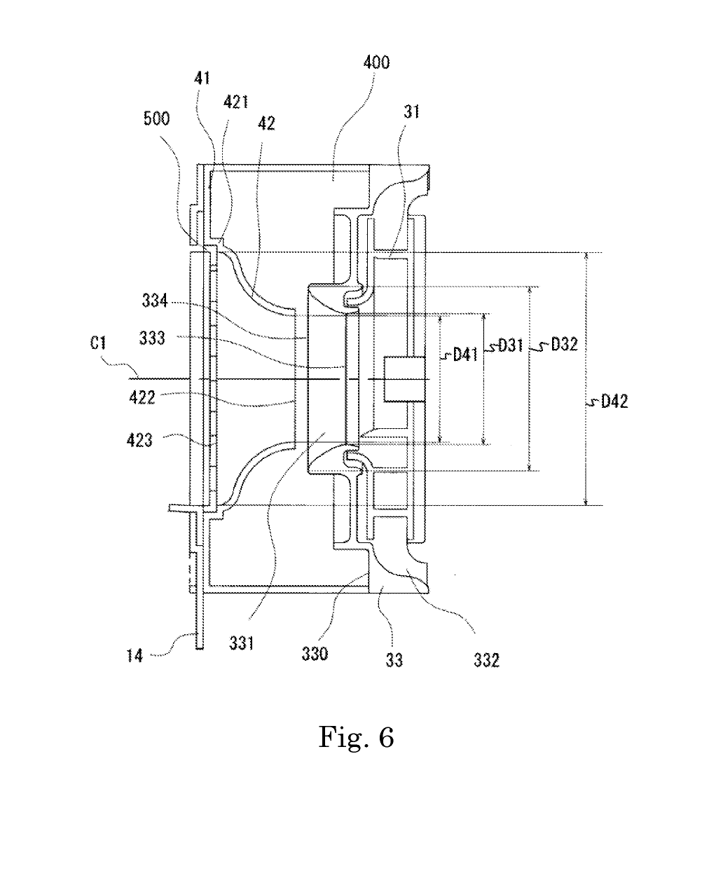

In the cyclone type dust collecting apparatus A illustrated above, it is more desirable that the flow velocity of the airflow is faster in order to separate the air and dust from each other. Meanwhile, when the flow velocity of the airflow is increased, noise such as wind noise, driving sound of the blower 300, and vibration and the like due to pressure of the airflow becomes larger. Accordingly, noise reduction is needed. In the cyclone type dust collecting apparatus A according to the present disclosure, an extension silencer is configured between the collection container 100 and the blower 300. Hereinafter, description of the extension silencer will be given. The extension silencer includes, in a duct through which a sonic wave passes, an extension chamber that is an extended portion of the duct. The sonic wave that has passed the duct is reflected in the portion where the duct has been extended. With the reflected wave, interference occurs inside the duct or in the extension chamber, and the energy of the sonic wave becomes attenuated. The noise is reduced in the extension silencer through the following principle. A configuration of an extension silencer according to the cyclone type dust collecting apparatus A according to the present disclosure will be described with reference to the diagrams. FIG. 6 is a cross-sectional view of an enlarged extension silencer of the cyclone type dust collecting apparatus according to the present disclosure. FIG. 7 is a drawing of a projection of the extension silencer illustrated in FIG. 6 in the axial direction.

As illustrated in FIG. 6, in the cyclone type dust collecting apparatus A, a gap is formed between the air outlet 42 and a front edge of the inlet 331. Furthermore, a side wall of the sleeve 400 surrounds the air outlet 42 and the inlet 331. The air outlet 42 and the inlet 331 are the duct through which the sonic wave passes. Furthermore, the space surrounded by the sleeve 400 and the cover 33 is the extension chamber. In other words, the gap is provided between an end portion of the air outlet 42 of the air blown out from the inner cylinder 200 and the inlet 331, and the extension silencer is formed between the collection container 100 and the blower 300. In other words, the gap is provided between an end portion of the inner cylinder 200 protruded outside of the collection container 100 and the inlet 331, and the extension silencer is formed between the collection container 100 and the blower 300. With the above, the noise of the cyclone type dust collecting apparatus A can be reduced.

As illustrated in FIG. 6, a gap is formed between a rear side end portion 422 of the air outlet 42 and a front side end portion 333 of the inlet 331. The sonic wave from the air outlet 42 or the inlet 331 enters the extension chamber surrounded by the sleeve 400 and the cover 33 through the gap. Furthermore, interference of the sonic wave reflected inside the extension chamber attenuates the sound.

As illustrated in FIG. 6, the air outlet 42 has a shape in which the inside diameter thereof becomes smaller (narrowed down) from the front side towards the rear side. Assuming that an inside diameter of the rear side end portion 422 is inside diameter D41, and an inside diameter of a front side end portion 423 is inside diameter D42, the inside diameter D41 is smaller than the inside diameter D42. Note that between the front side end portion 423 and the rear side end portion 422, the front side is larger than the rear side.

An inside diameter of the inlet 331 becomes smaller from the front side end portion 334 towards the rear side. Furthermore, the inside diameter becomes the smallest at a minimum position 333. While in the present embodiment, the minimum position 333 is a position offset to the front side from the rear side end portion of the inlet 331, the rear side end portion may be the minimum position. In other words, assuming that an inside diameter of the front side end portion 334 is inside diameter D32, and an inside diameter of the minimum position 333 is inside diameter D31, the inside diameter D32 is larger than the inside diameter D31.

The inside diameter D41 of the rear side end portion 422 of the air outlet 42 is larger than the inside diameter D31 of the minimum position 333 of the inlet 331. With such a configuration, separation in the flow of air blown out from the rear side end portion of the inlet 331 is suppressed, and noise can be suppressed. Note that the inside diameter D41 is preferably smaller than D32. With such a configuration, separation in the flow of air blown out from the air outlet 42 to the inlet 331 is suppressed, and noise can be suppressed.

As illustrated in FIG. 7, in the cyclone type dust collecting apparatus A according the present disclosure, portions of the impellers 311 of the vane wheel 31 are positioned inside the plane of projection of the rear side end portion 422 of the air outlet 42 in the front-rear direction. In other words, when viewing the rear side end portion 422 of the air outlet 42 from the front side in the central axis C1 direction, the impellers 311 of the vane wheel 31 can be seen. By forming in the above manner, the sound generated in the impellers 311 of the vane wheel 31 can easily enter the extension chamber of the extension silencer through the inlet 331. Accordingly, cancelling out of the sound generated in the impellers 311 is facilitated in the extension chamber, and the noise reduction effect is increased.

Generally, the magnitude of the noise reduction effect is determined by the ratio between the diameter of the inlet pipe towards the extension chamber and the outlet pipe from the extension chamber, and the diameter of the extension chamber. Furthermore, the frequency characteristics of the noise reduction is changed by the relationship between the lengths of the extension chamber, the inlet pipe, and the outlet pipe in the direction in which the sonic wave proceeds, and the wavelength. Note that the frequency characteristics herein means that there are frequencies in which the noise reduction effect is large and frequencies in which the noise reduction effect is small. Furthermore, the noise reduction effect of the extension silencer is effective not only for a single frequency but for a range of frequencies wide to a certain degree. According to the present embodiment, a generally effective noise reduction amount can be obtained.

In the extension silencer configured in the cyclone type dust collecting apparatus A of the present embodiment, the length of the sleeve 400 in the front-rear direction, the size of the gap between the air outlet 42 and the inlet 331, and the like can be changed. With the above, the frequency band of the noise reduced sonic wave can be changed. In other words, in the cyclone type dust collecting apparatus A, noise can be reduced by changing the sleeve 400 while considering the frequency characteristics of the noise determined by the specification and the rotation speed of the impeller of the blower. Furthermore, in the cyclone type dust collecting apparatus A, wind noise is generated by passing through a narrow flow path. Regarding the wind noise in the cyclone type dust collecting apparatus A as well, noise reduction can be performed by changing the sleeve 400.

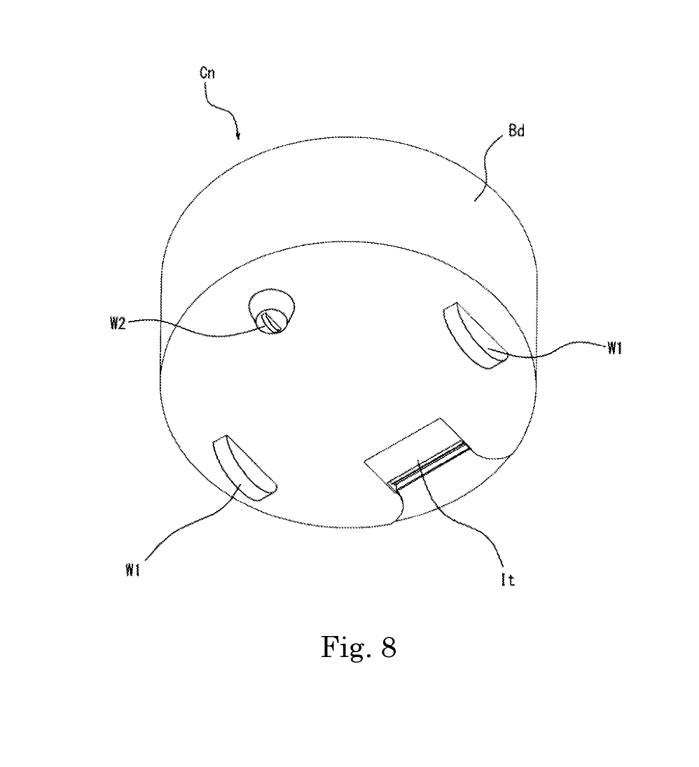

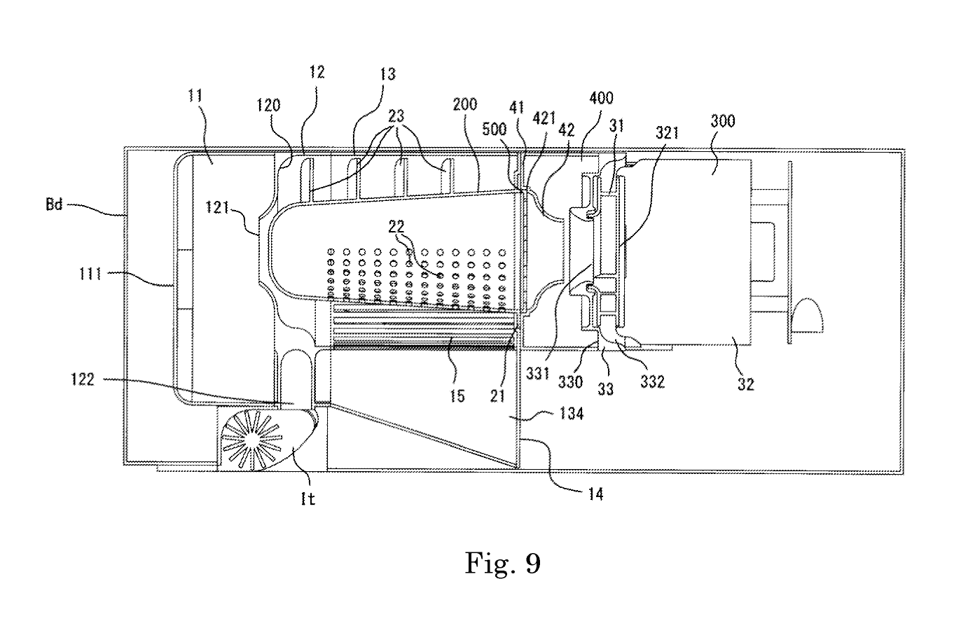

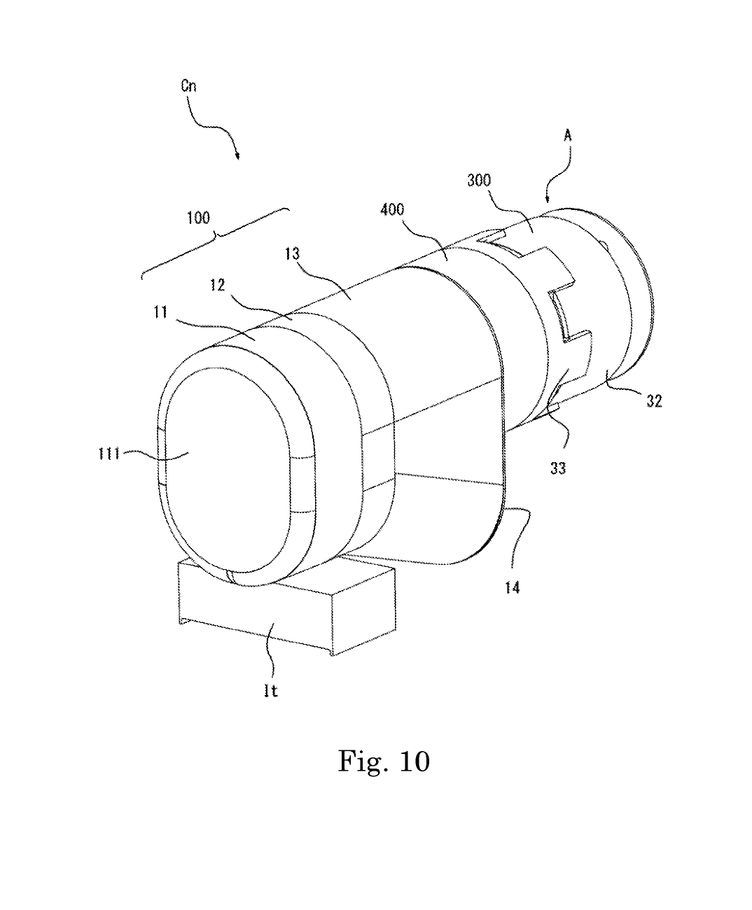

Referring to the diagrams, a vacuum cleaner using the cyclone type dust collecting apparatus according to the present disclosure will be described. FIG. 8 is a perspective view of the vacuum cleaner using the cyclone type dust collecting apparatus according to the present disclosure viewed from under. FIG. 9 is a cross-sectional view of the vacuum cleaner illustrated in FIG. 8. FIG. 10 is a perspective view illustrating an installed state of the cyclone type dust collecting apparatus illustrated in FIG. 8.

A vacuum cleaner Cn illustrated in FIG. 8 is an autonomous vacuum cleaner that automatically cleans a floor surface. The vacuum cleaner Cn includes two driving wheels W1 and a single steering wheel W2 on an underside thereof. Furthermore, an intake port It that suctions dust on the floor surface together with air is provided on the underside of the vacuum cleaner Cn. The vacuum cleaner Cn moves by turning the driving wheels W1. The steering wheel W2 turns about an axis of the vacuum cleaner Cn orthogonal to the floor surface and changes the moving direction of the vacuum cleaner Cn.

In the vacuum cleaner Cn, a sensor (not shown) is attached to a body Bd, which is an exterior. The vacuum cleaner Cn moves while avoiding obstacles. The vacuum cleaner Cn suctions dust on the floor surface by moving on the floor surface while driving the cyclone type dust collecting apparatus A.

As illustrated in FIGS. 9 and 10, in the cyclone type dust collecting apparatus A in the vacuum cleaner Cn, the accumulation area 134 of the swirl cylinder 13 is below the inner peripheral area 133. Furthermore, the inflow portion 122 provided under the air inflowing member 12 is connected to the intake port It. The intake port It is provided under the air intake member 12.

In the cyclone type dust collecting apparatus A according the present disclosure, the width of the lower portion of the collection container 100 is, towards the rear side, increased towards the lower side. Furthermore, the intake port It can be disposed in a gap between the front side end portion and the rear side end portion. As above, in the collection container 100, the front side is formed small compared to the rear side. Accordingly, the cyclone type dust collecting apparatus A can reduce the size of the front end side. With the above, the degree of freedom of disposition in the cyclone type dust collecting apparatus A can be increased.

In the cyclone type dust collecting apparatus A described above, the front lid 11 is used as a lid to discard the dust. However, not limited to the above, the dust may be discarded by opening and closing the dust collection cover 14. Furthermore, both the front lid 11 and the dust collection cover 14 may be openable and closable. In other words, in the cyclone type dust collecting apparatus A according the present disclosure, an openable and closable lid may be provided in at least a front end surface (the bottom surface 111) or a rear end surface (the dust collection cover 14) of the collection container 100. With the above, the dust accumulated in collection container 100 can be discarded easily.

In the cyclone type dust collecting apparatus A described above, a cross section (see FIG. 5 and the like) cut along a plane orthogonal to the front-rear direction of the collection container 100 has an oval shape extending in the up-down direction. However, not limited to the above, for example, the cross section cut along a plane orthogonal to the front-rear direction of the collection container may be a round shape. In other words, the second cross section cut along a plane orthogonal to the front-rear direction of the collection container may have a round shape. With such a configuration, since the swirl of the airflow passing at a high speed through the accumulation area has a round shape when viewed in the axial direction, pressure loss can be suppressed low.

Furthermore, the second cross section cut along a plane orthogonal to the front-rear direction of the collection container may have an elliptical shape, a combined shape of a semicircle and a semi-ellipsoid, or an oval shape. By so doing, the collection container can be reduced in size. Furthermore, the second cross section of the collection container is not limited to the above shapes, and a shape that does not easily create a turbulent flow in the airflow swirling inside can be widely employed. The shape in which the swirl flow does not easily become a turbulent flow includes, for example, a shape that is differentiable throughout the entire periphery.

In the cyclone type dust collecting apparatus described above, a first side in which the inner cylinder is held in between has an inclined cylindrical shape; however, not limited to the above, a cylindrical shape in which at least a portion of the front side is formed smaller than the rear side may be widely employed as the collection container. Furthermore, the collection container has a shape in which the width continuously increases from the front side to the rear side; however, not limited to the above, the collection container may have a cylindrical shape in which the width increases in a stepwise manner, for example.

In the cyclone type dust collecting apparatus illustrated in the embodiment described above, the front-rear direction is the horizontal direction, and the accumulation area is disposed so as to be positioned at the lower portion. However, not limited to the above, the front-rear direction may be a direction intersecting the horizontal direction, for example. Furthermore, the apparatus may be used while the front-rear direction is the vertical direction. When the front-rear direction is made to intersect the horizontal direction, by having the front lid be at the bottom, a configuration can be used in which the dust accumulated in the accumulation area is moved to the front lid.

In the cyclone type dust collecting apparatus illustrated in the embodiment described above, in the collection container, the front lid, the air intake member, and the swirl cylinder can be separated; however, the front lid, the air intake member, and the swirl cylinder may be formed as a same member. In a case in which the collection container is formed integrally, the inflow portion may have a pipe shape that is plunged into the collection container. Furthermore, the inner surface side of the collection container may be an opening extending along the inner surface.

While the embodiments of the present disclosure have been described above, the embodiments can be modified in various ways within the scope of the present disclosure.

The present disclosure can be used in an autonomously traveling vacuum cleaner, a futon vacuum cleaner, a dust collector of a vertical vacuum cleaner.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A cyclone type dust collecting apparatus comprising:
a collection container having a tubular shape extending in a front-rear direction, the collection container including a front end surface and a rear end surface;
an inflow portion into which air flows, the inflow portion being connected to a peripheral surface of the collection container; and
an inner cylinder that penetrates the rear end surface, a portion of the inner cylinder being disposed inside the collection container,
wherein the inner cylinder includes, at a peripheral surface in a portion disposed inside the collection container, an outlet through which the air flows out,
wherein the rear end surface has a width that is larger than that of the front end surface, and
wherein the inflow portion is disposed unevenly on a front side.

2. The cyclone type dust collecting apparatus according to claim 1,
wherein in a first cross section that is a cross section of the collection container including a central axis of the inner cylinder, among two sides that oppose each other with the inner cylinder in between, a first side is a line that includes two points in which distances to the central axis are different.

3. The cyclone type dust collecting apparatus according to claim 2,
wherein a second side of the first cross section is parallel to the central axis.

4. The cyclone type dust collecting apparatus according to claim 2,
wherein in the first cross section, at least a portion of the inner cylinder is, among the two sides of the first cross section that oppose each other with the inner cylinder in between, disposed unevenly on a second side.

5. The cyclone type dust collecting apparatus according to claim 2,
wherein the dust collecting container is disposed so that a front-rear direction is a horizontal direction, and
wherein the first side is disposed at a lower portion in an up-down direction orthogonal to the front-rear direction.

6. The cyclone type dust collecting apparatus according to claim 5,
wherein the outlet is formed at a portion opposing the first side of the first cross section of the inner cylinder.

7. The cyclone type dust collecting apparatus according to claim 1,
wherein the outlet is formed unevenly on a rear end surface side of the inner cylinder.

8. The cyclone type dust collecting apparatus according to claim 1,
wherein a second cross section cut along a plane orthogonal to the front-rear direction of the collection container has a round shape.

9. The cyclone type dust collecting apparatus according to claim 1,
wherein a second cross section cut along a plane orthogonal to the front-rear direction of the collection container has either an elliptical shape, a combined shape of a semicircle and a semi-ellipsoid, or an oval shape.

10. The cyclone type dust collecting apparatus according to claim 1,
wherein an openable and closable lid is provided in at least one of the front end surface and the rear end surface.

11. The cyclone type dust collecting apparatus according to claim 1, further comprising:
a blower that is connected to a rear side end portion of the collection container,
wherein the blower includes
a vane wheel that rotates about a central axis of rotation, and
a cover that surrounds the vane wheel,
wherein the cover includes an inlet open in a direction of the central axis of rotation, and
wherein when projected in the direction of the central axis of rotation, the central axis of rotation is disposed inside the inlet.

12. The cyclone type dust collecting apparatus according to claim 11,
wherein the blower is a centrifugal fan.

13. The cyclone type dust collecting apparatus according to claim 11,
wherein when the blower and the collection container are connected to each other, the central axis of the inner cylinder and a central axis of the inlet coincide each other.

14. The cyclone type dust collecting apparatus according to claim 13, further comprising:
a sleeve having a cylindrical shape open at both ends,
wherein a first end of the sleeve is connected to the collection container, and a second end of the sleeve is connected to the blower,
wherein a gap is provided between an end portion of the inner cylinder, the end portion being protruded outside the collection container, and the inlet, and
wherein an extension silencer is formed between the collection container and the blower.
